(19) United States
(12) Patent Application Publication
(10) Pub. No.: US 2025/0226920 A1
(43) Pub. Date: Jul. 10, 2025

(54) WIRELESS TRANSMISSION METHOD AND RELATED WIRELESS COMMUNICATION SYSTEM

(71) Applicant: Realtek Semiconductor Corp., HsinChu (TW)

(72) Inventors: Chia-Feng Liu, HsinChu (TW); Chiao-Ling Yang, HsinChu (TW)

(73) Assignee: Realtek Semiconductor Corp., HsinChu (TW)

(21) Appl. No.: 18/909,932

(22) Filed: Oct. 8, 2024

(30) Foreign Application Priority Data
Jan. 9, 2024 (TW) 113100921

(51) Int. Cl. H04L 1/08

(52) U.S. Cl. CPC H04L 1/08

(57) ABSTRACT

A wireless transmission method, for a wireless communication network having a transmission device and a reception device, wherein the wireless transmission method includes transmitting, by the transmission device, a first packet including at least a partial frame check sequence (PFCS) and retransmitting the first packet to the reception device; and combining, by the transmission device, the first packet and the first packet retransmitted by the transmission device as a complete packet; wherein no acknowledgement (ACK) message exists in a time sequence between the first packet, transmitted by the transmission device and the retransmitted first packet.

### BACKGROUND OF THE INVENTION

### 1. Field of the Invention

The present invention relates to a wireless transmission method and related wireless communication system, and more particularly, to a wireless transmission method and related wireless communication system, capable of increasing wireless transmission efficiency.

### 2. Description of the Prior Art

With the increase of wireless transmission of Wi-Fi, the data for transmission per time unit is increased. For the data frame, the whole packet cannot be utilized when any error occurs during the transmission process. For the management frame, the frame length of the beacon is increased with more supported functions, which increases the reception time period of the reception device, e.g., a wireless base station.

Since the frame check sequence (FCS) of the packet is placed at the end of the frame, in order to ensure to receive correct frame content, the reception device must receive the complete frame to know whether the transmission is successful or not. With the conventional mechanism, the wireless transmission efficiency of the frame is low.

Therefore, improvements are necessary to the conventional techniques.

### SUMMARY OF THE INVENTION

In light of this, the present invention provides a wireless transmission method and related wireless communication system to reduce a number of retransmission by the partial frame check sequence to increase wireless transmission efficiency.

An embodiment of the present invention discloses a wireless transmission method, for a wireless communication network having a transmission device and a reception device, wherein the wireless transmission method comprises transmitting, by the transmission device, a first packet including at least a partial frame check sequence (PFCS) and retransmitting the first packet to the reception device; and combining, by the transmission device, the first packet and the first packet retransmitted by the transmission device as a complete packet; wherein no acknowledgement (ACK) message exists in a time sequence between the first packet, transmitted by the transmission device and the retransmitted first packet.

Another embodiment of the present invention discloses a wireless transmission system, for a wireless communication network, comprises a transmission device, configured to transmit a first packet including at least a partial frame check sequence (PFCS) and retransmit the first packet; and a reception device, configured to combine the first packet and the retransmitted first packet from the transmission device as a complete packet; wherein no acknowledgement (ACK) message exists in a time sequence between the first packet, transmitted by the transmission device and the retransmitted first packet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the present invention.

FIG. 2 is a schematic diagram of a packet according to an embodiment of the present invention.

FIG. 3 is a schematic diagram of a wireless transmission process according to an embodiment of the present invention.

FIG. 4 is a schematic diagram of a data frame of a partial frame check sequence (PFCS) procedure according to an embodiment of the present invention.

FIG. 5 is a schematic diagram of a management frame of a PFCS procedure according to an embodiment of the present invention.

FIG. 6 is a schematic diagram of a wireless transmission process according to an embodiment of the present invention.

FIG. 7 is a schematic diagram of a beacon frame according to an embodiment of the present invention.

FIG. 8 is a schematic diagram of a wireless transmission method according to an embodiment of the present invention.

### DETAILED DESCRIPTION

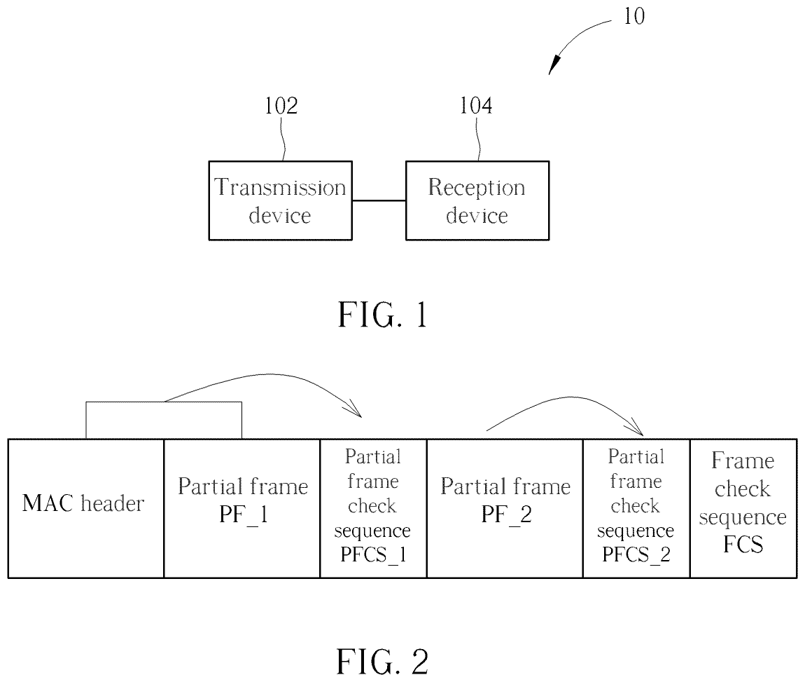

Please refer to FIG. 1, which is a schematic diagram of a wireless communication system 10 according to an embodiment of the present invention. The wireless communication system 10 is utilized for a wireless communication network, e.g., Wi-Fi wireless network, which includes a transmission device 102 and a reception device 104. The transmission device 102 may be an access point (AP) for transmitting a first packet having at least a partial frame check sequence (PFCS) and retransmitting the first packet to the reception device 104, wherein the first packet may be utilized for Ethernet frame of Ethernet network links. Compared to conventional frame check sequence (FCS), the partial frame check sequence according to an embodiment of the present invention may detect whether the packet data is damaged or not.

The reception device 104 may be a wireless terminal or a wireless station, for combining the first packet from the transmission device 102 and the first packet retransmitted by the transmission device 102 as a complete packet. Compared to conventional transmission of fragmentation, no acknowledgement (ACK) message exists in a time sequence between the first packet, transmitted by the transmission device 102 and the retransmitted first packet, i.e., no acknowledgement message exists between the period of the transmission and the retransmission of same packet by the transmission device 102, which decreases a contention period for channels. Therefore, the wireless communication system 10 according to an embodiment of the present invention may increase the wireless transmission efficiency.

Please refer to FIG. 2, which is a schematic diagram of a packet according to an embodiment of the present invention. In an embodiment, the packet according to an embodiment of the present invention includes a medium access control (MAC) header, partial frames PF_1, PF_2, partial frame check sequences PFCS_1, PFCS_2 and a frame check sequence FCS, wherein the frame check sequence FCS may be a 32-bits cyclic redundancy check (CRC) for detecting whether the data is damaged or not through the transmission, and each of the partial frame check sequences PFCS_1, PFCS_2 is determined according to the frame content between the current partial frame check sequence and a previous partial frame check sequence, or determined according to the frame content of the current partial frame check sequence.

In other words, in the example of FIG. 2, the partial frame check sequence PFCS_1 is determined according to the MAC header and the partial frame PF_1; the partial frame check sequence PFCS_2 is determined according to the partial frame PF_2. Therefore, the reception device 104 according to an embodiment of the present invention may assemble the complete packet according to the partial frame check sequences PFCS_1, PFCS_2, the first packet and the retransmitted first packet from the transmission device 102.

In order to ensure that whether the accuracy of part of the content of the packet through the partial frame check sequence is correct or not, the transmission device 102 of the wireless communication system 10 according to an embodiment of the present invention communicates a packet length with the reception device 104 in advance to determine at least a partial frame check sequence PFCS in the packet. The reception device 104 calculates the partial frame check sequence PFCS according to the predetermined packet length to determine whether the content of the partial frame is correct or not.

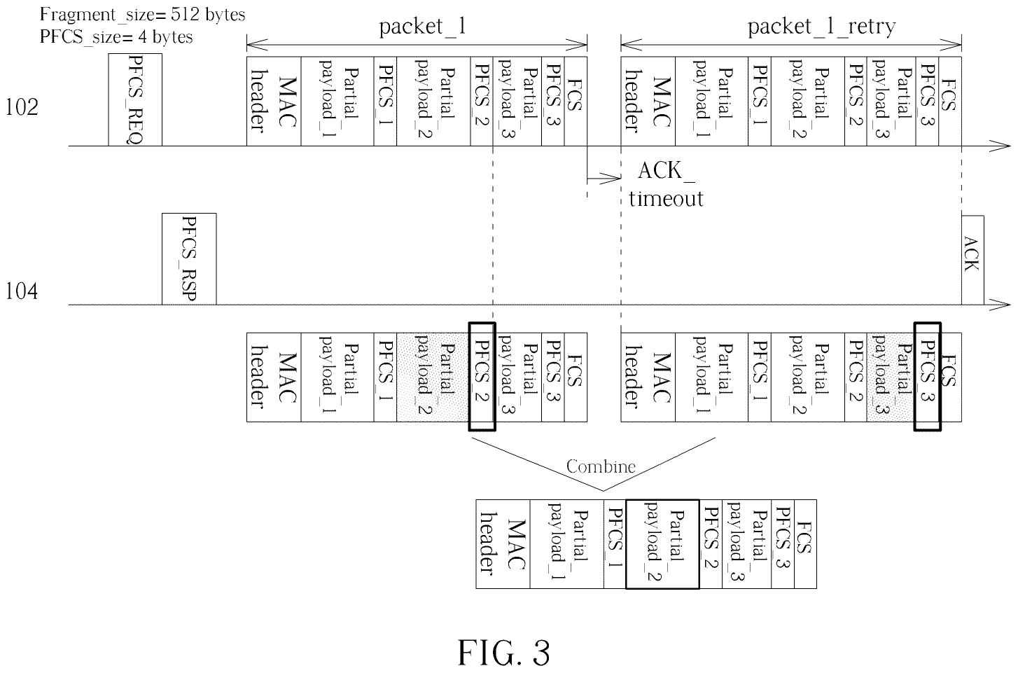

Please refer to FIG. 3, which is a schematic diagram of a wireless transmission process 30 according to an embodiment of the present invention. A PFCS procedure between the transmission device 102 and the reception device 104 is determined to be activated or not according to a PFCS handshake. The example illustrates a single link scenario of the partial frame check sequence PFCS, after the transmission device 102 transmits a PFCS request frame PFCS_REQ to the reception device 104, the reception device 104 transmits a PFCS response frame PFCS_RSP to the transmission device 102 to determine whether or not to activate the PFCS procedure and to negotiate positions of the packet for the partial frame check sequence PFCS.

As shown in FIG. 3, the transmission device 102 transmits a packet packet_1 to the reception device 104, and the reception device 104 may respectively detect whether any error exists in partial content of the packet according to the partial frame check sequence PFCS_1, the partial frame check sequence PFCS_2 and the partial frame check sequence PFCS_3. In the example, the reception device 104 may determine whether the content of partial frame is correct or not according to the packet length, i.e., a fragment size Fragment_size is 512 bytes and a partial frame check sequence size PFCS size is 4 bytes, which is determined with the transmission device 102 in advance. That is, error exists in partial data partial_payload_2 of the packet packet_1 transmitted by the transmission device 102 and partial data partial_payload_3 of a packet packet_1_retry retransmitted by the transmission device 102. The partial frame check sequence PFCS_2 of the packet packet_1 mismatches with the calculated value of the partial data partial_payload_2, which indicates that more than one error exists in the partial data partial_payload_2. Notably, since error exists in partial data partial_payload_2 of the packet packet_1 transmitted by the transmission device 102, the reception device 104 is not sure whether to drop the frame or not. After an acknowledgement timeout ACK_timeout, the transmission device 102 transmits the packet packet_1_retry. In other words, no ACK message exists between the packet packet_1 transmitted by the transmission device 102 and the packet packet_1_retry retransmitted by the transmission device 102 in the time sequence. The partial frame check sequence PFCS_3 of the packet packet_1_retry mismatches with the calculated value of the partial data partial_payload_3, which indicates that more than one error exists in the partial data partial_payload_3.

In such situation, the reception device 104 may assemble partial correct data of the received the packets packet_1, packet_1_retry as the complete packet to decrease a retransmission number and increase a utilization efficiency of frequency. Therefore, the wireless transmission method according to an embodiment of the present invention may reduce the time for channel contention and the ACK transmission.

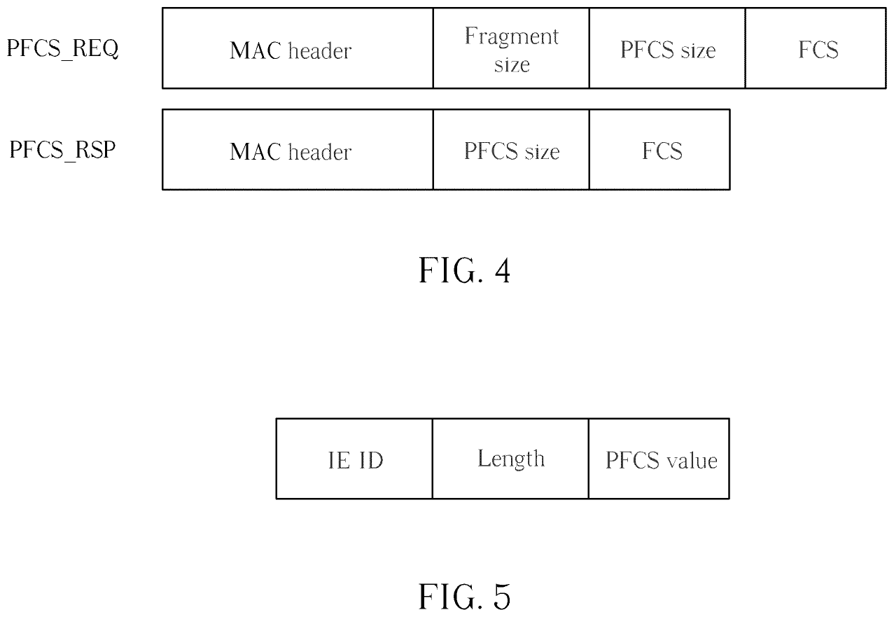

Please refer to FIG. 4, which is a schematic diagram of a data frame of the PFCS according to an embodiment of the present invention. The data frame may be utilized for assembling the complete and correct data frame according to partial correct data of the packet, wherein the PFCS request frame PFCS_REQ of the data frame includes an MAC header, a fragment size, a partial frame check sequence size and a frame check sequence (FCS); the PFCS response frame PFCS_RSP of the data frame includes an MAC header, a partial frame check sequence state and a frame check sequence (FCS), wherein the partial frame check sequence state may include state of deny, accept or suggest, which provides the fragment size, the partial frame check sequence size to the PFCS request frame PFCS_REQ. As shown in FIG. 4, the partial frame check sequence size is inserted in the PFCS request frame PFCS_REQ next to a fragment size frame to detect an accuracy of partial content.

Please refer to FIG. 5, which is a schematic diagram of a management frame of the PFCS procedure according to an embodiment of the present invention. The management frame may directly utilize correct messages, which includes an information element (IE) ID, a length and a partial frame check sequence value. The information element (IE) ID is added to the management frame to ensure the accuracy and the integrity of partial content of the frame.

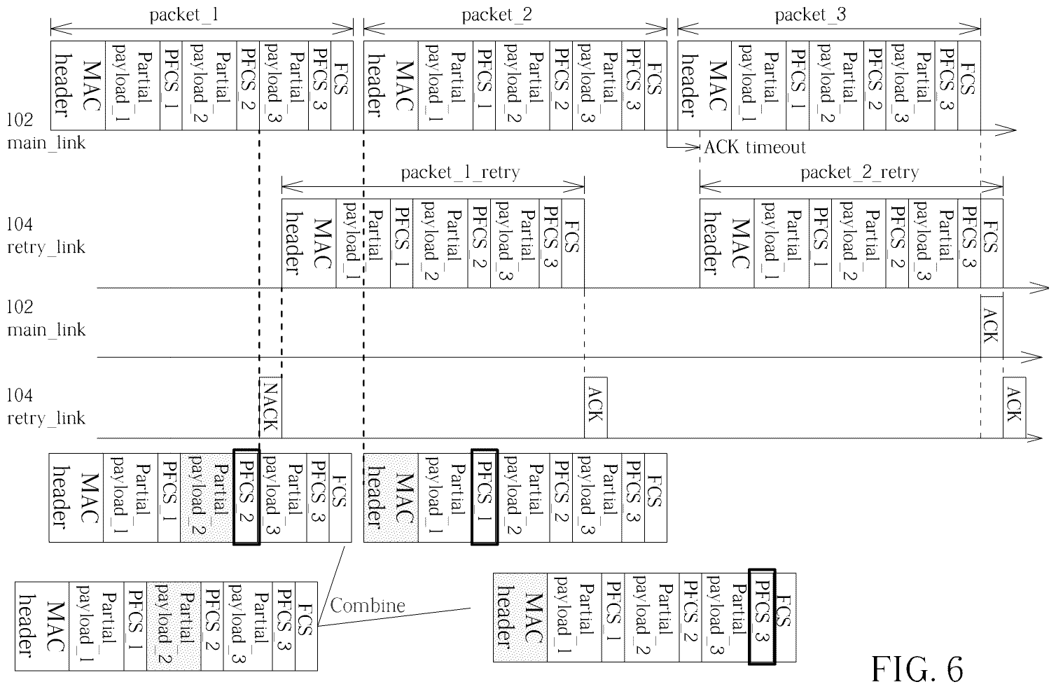

Please refer to FIG. 6, which is a schematic diagram of a wireless transmission process 60 according to an embodiment of the present invention. For simplicity, the PFCS handshake between the transmission device 102 and the reception device 104 is neglected in FIG. 6. Different to the wireless transmission method 30, the wireless transmission method 60 illustrates a multi-link multi-radio scenario for Wi-Fi 7 wireless communication system. In this scenario, a main link main link and a retransmission link retry_link exist between the transmission device 102 and the reception device 104. The transmission device 102 transmits the frames via the main link main link for the first time, and retransmits the frames via the retransmission link retry_link. The reception device 104 combines the packet packet_1 and the packet packet_1_retry retransmitted by the transmission device 102 as the complete packet.

As shown in FIG. 6, the transmission device 102 transmits the packet packet_1, the packet packet_2 and the packet packet_3 via the main link main link, and transmits the packet packet_1_retry and the packet packet_2_retry via the retransmission link retry_link.

After the transmission device 102 transmits the packet packet_1 to the reception device 104, the reception device 104 detects that error exists in the partial data partial 2 according to the partial frame check sequence PFCS_2. Thus, a negative-acknowledgment (NACK) is sent on the retransmission link retry_link, such that the transmission device 102 may retransmit the packet packet_1 via the retransmission link retry_link. After the transmission device 102 transmits the packet packet_1_retry via the retransmission link retry_link, the reception device 104 combines the packet packet_1 from the main link main link and the packet packet_1_retry from the retransmission link retry_link as the complete packet, and transmits the acknowledgement ACK via the retransmission link retry_link. That is, in the scenario of multi-link multi-radio scenario, the reception device 104 transmits the acknowledgement ACK on the link, where receives the packet (i.e., the packet packet_1_retry) for assembling the complete packet.

Since error exists in the partial data partial_payload_1 of the packet packet_2 received by the reception device 104, the reception device 104 cannot determine the error content exists in the MAC header or the partial data partial_payload_1 according to the partial frame check sequence PFCS_1, the reception device 104 cannot decide whether to drop the frame reception or not. Therefore, the reception device 104 retransmits the packet packet_2_retry via the retransmission link retry_link after the acknowledgement timeout ACK_timeout, and transmits the acknowledgement ACK via the retransmission link retry_link after receives a complete packet packet_2 via the retransmission link retry_link. In addition, the transmission device 102 transmits the packet packet_3 via the main link main link to the reception device 104, and responses the acknowledgement ACK via the main link main link after successfully receives the packet packet_3.

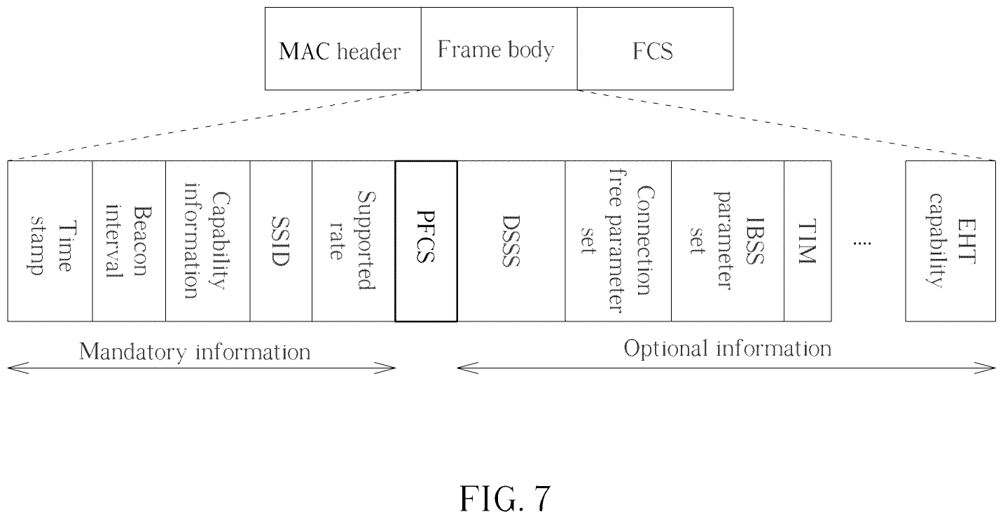

FIG. 7 is a schematic diagram of a beacon frame according to an embodiment of the present invention. In the example of FIG. 7, the beacon frame is composed of information elements, which includes a MAC header, a frame body and a frame check sequence, wherein the frame body may include mandatory information and optional information. The information element of mandatory information may include a time stamp, a beacon interval, a capability information, a service set Identifier (SSID), a supported rate, and the information element of optional information may include a direct-sequence spread spectrum (DSSS), a connection free parameter set, an independent basic service set (IBSS) parameter set, a traffic indication map (TIM), an EHT capability, but not limited thereto. In this example, the partial frame check sequence PFCS may be placed behind the mandatory information to ensure the accuracy of specific columns placed before the partial frame check sequence.

In an embodiment, assume that error exists in the content of traffic indication map (TIM), but the comparison of the partial frame check sequence PFCS is identical by the reception device 104, which represents that the content of the received mandatory information is correct, the reception device 104 may perform a synchronization with the transmission device 102 based on the content of time stamps. In another embodiment, assume that the optional information is redundant to the reception device 104, the reception device 104 may determine that the partial frame check sequence PFCS is correct and perform the synchronization according to the content of the mandatory information with the transmission device 102 after the reception device 104 receives the partial frame check sequence PFCS. Alternatively, when the reception device 104 determines that the partial frame check sequence PFCS is different to the predetermined one, consequent packets are dropped and the reception device 104 enters a sleep state to save power.

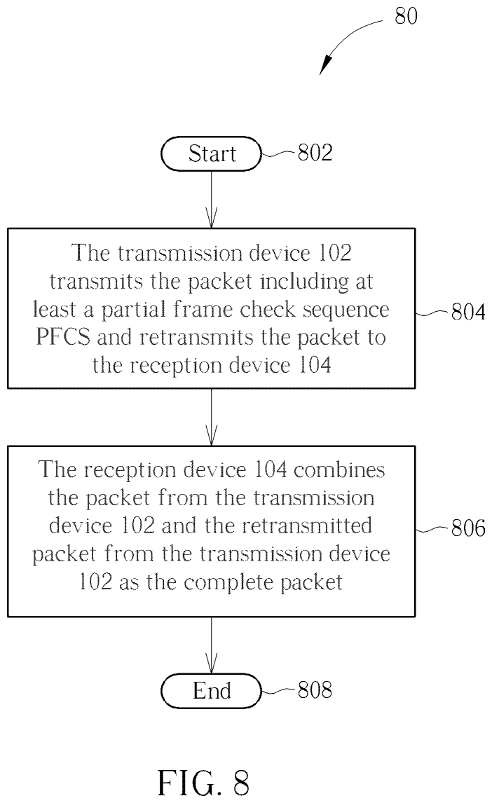

An operation method of the wireless communication system 10 may be summarized as a wireless transmission method 80, as shown in FIG. 8, the wireless transmission method 80 includes the following steps:
Step 802: Start;
Step 804: The transmission device 102 transmits the packet including at least a partial frame check sequence PFCS and retransmits the packet to the reception device 104;
Step 806: The reception device 104 combines the packet from the transmission device 102 and the retransmitted packet from the transmission device 102 as the complete packet;
Step 808: End.

Refer to the embodiments of the wireless transmission method 80 mentioned above for the operation process of the wireless communication system 10, which is not narrated herein for brevity.

Notably, the beacon frame and the number of the partial frame check sequence in the packet of the above embodiments may be modified according to different requirements, which are all within the scope of the present invention.

In summary, the present invention discloses a wireless transmission method and related wireless communication system to reduce a number of retransmission by the partial frame check sequence to increase wireless transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless transmission method, for a wireless communication network having a transmission device and a reception device, wherein the wireless transmission method comprising:
transmitting, by the transmission device, a first packet including at least a partial frame check sequence (PFCS) and retransmitting the first packet to the reception device; and
combining, by the transmission device, the first packet and the first packet retransmitted by the transmission device as a complete packet;
wherein no acknowledgement (ACK) message exists in a time sequence between the first packet, transmitted by the transmission device and the retransmitted first packet.

2. The wireless transmission method of claim 1, wherein a first PFCS of the at least a PFCS is determined according to frame content of a previous PFCS or the first PFCS.

3. The wireless transmission method of claim 1, wherein a partial frame check sequence procedure between the transmission device and the reception device is determined to be activated or not according to a partial frame check sequence handshake.

4. The wireless transmission method of claim 3, wherein the partial frame check sequence handshake is to determine whether or not to activate the PFCS procedure, a length of the at least a PFCS and a length of the frame according to a PFCS request frame and a PFCS response frame.

5. The wireless transmission method of claim 1, wherein the reception device is configured to determine whether content of the partial frame is correct or not according to the at least a PFCS of the first packet.

6. The wireless transmission method of claim 1, wherein when the wireless communication network is in a multi-link multi-radio scenario, a main link and a retransmission link exist between the transmission device and the reception device, the reception device is configured to combine the first packet and the first packet retransmitted by the transmission device as the complete packet.

7. The wireless transmission method of claim 6, wherein the transmission device is configured to transmit the first packet via the main link and retransmit the first packet via the retransmission link.

8. The wireless transmission method of claim 6, wherein the reception device is configured to transmit an acknowledgement (ACK) on a link where the complete packet is combined.

9. A wireless transmission system, for a wireless communication network, comprising:
a transmission device, configured to transmit a first packet including at least a partial frame check sequence (PFCS) and retransmit the first packet; and
a reception device, configured to combine the first packet and the retransmitted first packet from the transmission device as a complete packet;
wherein no acknowledgement (ACK) message exists in a time sequence between the first packet, transmitted by the transmission device and the retransmitted first packet.

10. The wireless transmission system of claim 9, wherein a first PFCS of the at least a PFCS is determined according to frame content of a previous PFCS or the first PFCS.

11. The wireless transmission system of claim 9, wherein a partial frame check sequence procedure between the transmission device and the reception device is determined to be activated or not according to a partial frame check sequence handshake.

12. The wireless transmission system of claim 11, wherein the partial frame check sequence handshake is to determine whether or not to activate the PFCS procedure, a length of the at least a PFCS and a length of the frame according to a PFCS request frame and a PFCS response frame.

13. The wireless transmission system of claim 9, wherein the reception device is configured to determine whether content of the partial frame is correct or not according to the at least a PFCS of the first packet.

14. The wireless transmission system of claim 9, wherein when the wireless communication network is in a multi-link multi-radio scenario, a main link and a retransmission link exist between the transmission device and the reception device, the reception device is configured to combine the first packet and the first packet retransmitted by the transmission device as the complete packet.

15. The wireless transmission system of claim 14, wherein the transmission device is configured to transmit the first packet via the main link and retransmit the first packet via the retransmission link.

16. The wireless transmission system of claim 14, wherein the reception device is configured to transmit an acknowledgement (ACK) on a link where the complete packet is combined.
